(19) United States
(12) Patent Application Publication
(10) Pub. No.: US 2011/0152408 A1
(43) Pub. Date: Jun. 23, 2011

(54) COATING COMPOSITIONS AND PROCESSES FOR MAKING THE SAME

(75) Inventors: Nicolas Cunningham, Brampton (CA); Stephen J. Edmondson, Oakville (CA); Dennis T. H. Wong, Toronto (CA)

(73) Assignee: SHAWCOR LTD., Toronto, ON (CA)

(21) Appl. No.: 12/995,040

(22) PCT Filed: May 28, 2009
(86) PCT No.: PCT/CA2009/000691

§ 371 Date: Mar. 10, 2011

(30) Foreign Application Priority Data
May 30, 2008 (CA) 2,632,802

(51) Int. Cl. C09D 163/00; B05D 3/00; C09D 123/26; C09D 115/00

(52) U.S. Cl. 523/437; 427/398.1

(57) ABSTRACT

Coating composition includes curable epoxy resin in solid form, curing agent for the epoxy resin, and filler. Further, there is a polyolefin containing component having a compatibilizer polymer that is a modified polyolefin, a mixture of a polyolefin or olefin copolymer with a functionalized rubber, or both. The modified polyolefin and functionalized rubber contain groups reactive with either the epoxy resin or the epoxy curing agent. A polyolefin-based portion that amounts to at least 50% by weight of the polyolefin containing component, and an epoxy-based portion that amounts to at least 50% by weight of the curable epoxy resin have viscosities such that the difference between the viscosity of the polyolefin-based portion and the viscosity of the epoxy-based portion, expressed as a percentage based on the lower of the two viscosities, is less than 40%. These viscosities are measured by ASTM D4440 at the Vicat softening points, as measured by ASTM D 1525.

The present invention relates to coating compositions, processes for making them, and methods of application of the coating compositions.

More especially, although not exclusively, such coating compositions may be used as anti-corrosion coatings on metal substrates, for example on elongated metal tubular substrates, such as pipe.

U.S. Pat. No. 5,178,902 assigned to the present applicant describes a high performance composite coating (HPCC) comprising three layers of material, namely a fusion bond epoxy (FBE), an adhesive layer, and a polyolefin top coat. The drawback of this HPCC approach is that the cost of such a system is significantly higher than the main competitive system, which is an FBE only single layer coating.

Single layer FBE coatings are, however, known to be prone to impact damage during transportation, and are also prone to blistering when exposed to elevated temperatures (above 50° C.) in hot and wet environments due to moisture permeation through the film.

The coating compositions of the present invention are intended to provide superior performance to a single layer FBE coating at a cost that is the same as, or is at least competitive with the cost of a single layer FBE coating.

Specifically, preferred embodiments of the present invention are intended to provide performance improvements over single layer FBE in improved resistance to moisture permeation and damage caused by impact when applied as a dual layer on FBE. It can also be applied on a substrate as a single layer with acceptable properties for most applications.

As compared with the HPCC coating, preferred embodiments of the present invention are intended to be less expensive while providing a simplified application method.

Applicant is aware of prior approaches in U.S. Pat. Nos. 5,198,497 (Mathur), 5,709,948 (Perez et al) and WO 2007/022031 published Feb. 22, 2007 (Perez et al). In these, relatively high temperatures are required during the blending of the composition in order to polymerize the epoxy resin component. These high temperatures require the use of higher polyolefins, such as polypropylene, which have a viscosity comparable to that of the epoxy at the high processing temperatures. A disadvantage is that there is difficulty in employing polyethylene, which is generally of lower cost than polypropylene, in the process as described. At the high processing temperatures, polyethylene with suitable melt flow indexes for this process may possess a lower viscosity than other polyolefins such as polypropylene. As a result, the polyethylene may not blend well with the epoxy and this would cause one of the components to separate out of the mixtures after compounding.

Further, applicant is aware of polyolefin and epoxy resin mixtures proposed in U.S. Pat. No. 4,345,004 (Miyake et al). However, blends exemplified in the Miyake et al patent are not as stable as may be considered desirable as the epoxy component tends to separate as a phase separate from the polyolefin component, or the blends require solvents for application. The latter present problems of porosity of the coating as a result of off-gassing of solvent residue.

In one preferred form of the present invention, there is provided a coating composition comprising in admixture:

(A) a curable epoxy resin in solid form;

(B) a curing agent for the epoxy resin;

(C) a polyolefin containing component comprising at least one of (i) a compatibilizer polymer that is a modified polyolefin or (ii) a mixture of a polyolefin or olefin copolymer with a functionalized rubber; said modified polyolefin and said functionalized rubber containing functional groups reactive with either the epoxy resin or epoxy curing agent; and

(D) a filler in particulate form,

wherein a polyolefin-based portion amounting to at least 50% by weight of said polyolefin containing component (C) and an epoxy-based portion amounting to at least 50% by weight of said curable epoxy resin (A) have viscosities such that the difference between the viscosity of said polyolefin-based portion and the viscosity of said epoxy-based portion, expressed as a percentage based on the lower of the two viscosities, is less than 40%, wherein said viscosities of said polyolefin-based portion and of said epoxy-based portion are measured by ASTM D4440 at the Vicat softening points thereof as measured by ASTM D1525.

Further, said composition preferably contains in said component (C) a polyolefin, a copolymer thereof, or a mixture thereof.

While, as discussed in more detail below, the above-described composition may in one form advantageously be provided as a dry blend of the components in fine particulate form suitable for spray application, in a preferred form, the composition is melt processed to provide a solid preferably substantially homogeneous blend having said filler substantially uniformly distributed therein. In the above-described coating composition, the epoxy resin is provided in solid form, rather than in the form of a liquid epoxy resin as in the U.S. patents to Mathur and Perez et al and in the Perez et al WO publication mentioned above. Whereas, in the proposals using liquid epoxy, higher temperatures are required in order to further polymerize the liquid epoxy, in the above described composition lower temperatures may be employed when blending the composition since there is no need to polymerize the epoxy and, accordingly, polyethylene, one or more polyethylene copolymers or a mixture thereof may be employed as an ingredient in the polyolefin-containing component, since at the relatively lower processing temperatures, the viscosity of the polyethylene or copolymer may be matched to that of the epoxy resin, so that compounding of the mixture to form a substantially homogeneous coherent mass is possible.

By way of further explanation, in the preferred form described above, the viscosity of the polyolefin, or of each polyolefin, or polyolefin copolymer contained in the polyolefin-containing component is that as reported at its Vicat softening point, as measured by ASTM D1525. The viscosity measurement is that reported by viscosity measurement prescribed by ASTM D4440, at the Vicat softening point.

Further, in the preferred form described above, by the viscosity of the solid epoxy resin, (A) or of each curable epoxy resin in solid form present in (A) in the event that (A) comprises a mixture of curable epoxy resins in solid form, is meant that as reported at its Vicat softening point, as measured by ASTM D1525. The viscosity is that as reported, at the said softening point, in accordance with ASTM D4440.

In the case in which the polymer or resin has a range of softening points, reference is made to the lowest temperature in that range.

In the preferred form, in order to avoid an excessive tendency for one component or the other to separate out from the blend, when subjected to compounding and melt processing, it is preferred that a substantial portion of the polyolefin containing component (C) has its viscosity closely matched to that of a substantial portion of the curable epoxy resin in solid form (A). Preferably, the viscosity difference between the said substantial portion of the curable epoxy resin and the said substantial portion of the polyolefin containing component is less than 40%. This percentage difference is conveniently expressed as the difference between the two viscosities, expressed in SI units, taken as a percentage based on the lower of the two viscosities, and is used in the present specification in that sense.

Applicant has found that when the difference in viscosities between substantial portions of the said curable epoxy resin and of the said polyolefin containing component is in excess of about 40%, there is increased tendency for phase separation to occur when the mixture is heated to elevated temperature, for example during and after compounding, whereby a portion of the polyolefin containing component remains or becomes a separate phase, resulting in a product that may be considered undesirably heterogeneous in some applications. Hence, while a composition having its above-mentioned difference in viscosity greater than 40% may be usable in some applications, it is not preferred. More preferably the difference in viscosities is less than 30%, still more preferably less than 20%, more preferably still less than 10% and most preferably less than 5%.

In the preferred form, as noted above, at least 50% by weight of each of the polyolefin containing component (C) and the curable epoxy resin in solid form (A) exhibit viscosity differences within the preferred maxima described above. Compositions having less than 50% of the polyolefin containing component (C) or of the curable epoxy resin in solid (A) provide coatings that are acceptable for some applications. However, they tend to exhibit a higher degree of heterogeneity as a result of somewhat increased phase separation between the polyolefin, polyolefin copolymer, and epoxy moieties. More preferably, the polyolefin-based portion and the epoxy-based portion conforming to above preferred maximum viscosity differences are at least 60% by weight, still more preferably at least 70% by weight, even more preferably at least 80% by weight, and most preferably at least 90% by weight.

In the preferred form, to facilitate compounding of the composition, the Vicat softening points as determined by ASTM D1525, of the polyolefin containing component (C) and of the curable epoxy resin (A) are within a span of 30° C. of one another, i.e. differ by less than 30° C., more preferably within 20° C., even more preferably within 15° C., still more preferably within 10° C. and most preferably within 5° C. In the case in which the polymer or resin has a range of Vicat softening points, reference to the lower end of the softening point range is intended.

In some compositions in accordance with the invention, the polyolefin containing component (C) or the curable epoxy resin component (A) comprises a mixture of polymers, for example (C) comprises a mixture of different polyolefin-based polymers, or (A) comprises a mixture of different curable epoxy resins in solid form. In such case, it is preferred that at least 50% by weight of the respective component (C) or (A) has its Vicat softening point within the temperature spans mentioned above in comparison to the Vicat softening point of the other component. During the course of compounding at elevated temperature, once a substantial portion of a component has softened or melted, it serves as a solvent that solubilizes the other more refractory components of the mixture and brings them into the liquid phase.

The above-described preferred compositions may be provided in the form of a mixture wherein each of the components thereof is in finely divided form suitable for, for example, particulate spray application to a heated metallic substrate, for example pipe. The polyolefin containing component, curable epoxy in solid form and, if necessary, the curing agent may, if required, be pulverized to a fine particle size suitable for spray application. Conventional pulverization techniques may be employed, for example grinding at low temperature as described in the above-mentioned Miyaka et al U.S. Pat. No. 4,345,004, the disclosures of which are incorporated herein by reference. In one form, the finely divided ingredients of the composition are maintained in a fluidized bed in order to provide a substantially homogeneous fluidized volume from which particles are withdrawn to be passed to the spray application heads.

Desirably, in such case, the density of the filler particles is approximately similar to the densities of the polyolefin containing component, epoxy resin and curing agent, to reduce a tendency for filler particles to segregate from the remaining materials in the bed. Preferably the density of the filler is no more than 10% greater than the density of the densest of the remaining materials, more preferably less than 5% greater. It may be noted such segregation occurs only when the filler is added post compounding as a separate particulate material. When the filler are added during compounding the density discrepancy is not a problem as an homogeneous blend is obtained with an equally homogeneous density.

Conventional spray application techniques can be employed, for example as described in Wong et al U.S. Pat. No. 5,178,902, the disclosures of which are incorporated herein by reference.

In the preferred form, the composition is provided in a dry form, substantially wholly free of a solvent for any ingredient of the composition. In this instance, ‘solvent’ refers to a solvent that is liquid at room temperature, i.e., at 20° C. The presence of solvents in the coating composition may tend to result in undesired porosity in the eventual coating, as a result of pores formed by evaporation of the solvent during or after completion of the coating procedure.

More preferably, however, in order to facilitate application of the coating composition, the ingredients thereof are compounded together at elevated temperature rendering the polyolefin containing component (C) and epoxy resin (A) flowable. In a preferred form the flowable mixture forms a substantially homogeneous blend.

In a further preferred form of the present invention, there is provided a process for forming a coating composition comprising blending together a mixture comprising:

(A) a curable epoxy resin in solid form;

(B) a curing agent for the epoxy resin;

(C) a polyolefin containing component comprising at least one of (i) a compatibilizer polymer that is a modified polyolefin or (ii) a mixture of a polyolefin or olefin copolymer with a functionalized rubber; said modified polyolefin and said functionalized rubber containing functional groups reactive with either the epoxy resin or epoxy curing agent; and

(D) a filler in particulate form,

including conducting said blending at a temperature sufficiently elevated to render said polyolefin containing component (C) and said epoxy resin (A) flowable and blending in flowable state to form a flowable blend, and allowing said mixture to cool to form a solid blend.

The procedures used for blending together meltable polymeric components at elevated temperature, for example to form a substantially homogeneous blend, are well known to those skilled in the art and need not be described in detail herein. Examples of suitable procedures are described in the above-mentioned Mathur U.S. Pat. No. 5,198,497, the disclosures of which are incorporated herein by reference.

Desirably, for the reasons described above, in the present process, a substantial portion of the polyolefin containing component (C) has its viscosity closely matched to that of a substantial portion of the curable epoxy resin in solid form (A), as described in the preceding description in more detail.

Further, for the reasons discussed above, desirably at least 50% by weight of the polyolefin containing component (C) has its Vicat softening point within the temperature spans discussed above, in comparison to the Vicat softening point of at least 50% by weight of the curable epoxy resin (A). As before, the Vicat softening points referred to are those as determined by ASTM D1525.

In one preferred form the solid blend obtained with the present process may be pulverized to fine particle size and spray applied to a substrate, as described in more detail above.

In a further preferred form, the blend obtained with the present process may, before solidification, be applied in liquid or softened form directly to a substrate to be coated, for example an elongated metallic object, such as metal pipe.

In a still further preferred form, the coating composition in accordance with the invention is compounded, for example using conventional compounding techniques, and pelletized and cooled to provide solid pellets. The pellets may subsequently be used as the feed for conventional apparatus for applying a coating in liquid or softened form to a substrate to be coated, for example metal pipe or other elongated metallic object. The application procedure may for example comprise conventional crosshead extrusion or side wrap extrusion procedure. The liquid or softened coating is allowed to cool and solidify on the pipe or other substrate to form a protective coating thereon.

In some cases, it may be found difficult to control the temperature of the composition during the compounding procedure. In such case, it has been found that better control of the compounding temperature can be achieved by formulating the composition as two separate parts, one of which contains all or a fraction of said curable epoxy resin and the other of which contains all or a fraction of said curing agent for the epoxy resin. In a preferred form the composition of each part is selected so that when the two parts are blended together in a predetermined weight ratio, the resulting composition is in accordance with the preferred forms of the composition described in more detail below.

Usually, the substrate is coated with FBE in conventional manner before application of the present composition. Following application of the FBE to the hot substrate, the FBE liquefies, gels (turns from a flowable liquid to a non-flowable gel) and commences to cure. In the preferred form, the present coating is applied before the FBE is fully cured. Application after full cure tends to result in poor adhesion of the coating to the epoxy layer. Adhesion to a fully cured epoxy layer can be improved by various expedients, for example abrading the epoxy layer, and applying an adhesion promoter, but these expedients are inconvenient and expensive. The time taken for the epoxy to fully cure, as well as the time taken for the epoxy to gel, are dependent on the surface temperature of the pipe or other substrate. As is well understood by one of ordinary skill in the art, in, for example, pipe coating plant, the surface temperature of the pipe and the time taken for the FBE to gel will depend on a number of factors such as plant configuration, environmental conditions, pipe thickness, spray booth design, and heating coil design, among others. As a practical matter, factors such as heat losses and FBE cure rate restrict the maximum period of time for which application of preferred forms of the present coating may be deferred following FBE application, while still obtaining a coating having desired properties.

In the preferred form, the preferred coating is applied at a time after FBE application that is 0.1 to 4.5, preferably 0.5 to 2, and more preferably equal to the gel time of the FBE at the surface temperature of the substrate. Such surface temperature is preferably that at the time of FBE application.

Procedures suitable for application of such liquid or softened coatings to substrates are well known to those skilled in the art, and are described in, for example, Trzecieski et al U.S. Pat. No. 5,026,451, and in WO 2007/095741 in the name of the present applicant, the disclosures of both of which are incorporated by reference herein.

In preferred forms of the present invention, the compositions thus applied provide excellent protective properties. The polyolefin containing component provides resistance to moisture penetration, the epoxy resin component provides enhanced corrosion resistance and adhesion to the substrate's outermost layer which may usually be an FBE, and the filler imparts resistance to damage to the coating caused by impact and increases the hardness as measured using ASTM D2240.

The polyolefin containing component of the composition may consist substantially wholly of said compatibilizer polymer that is a modified polyolefin containing functional groups reactive with either the epoxy resin or epoxy curing agent. Such compositions, however, tend to exhibit reduced resistance to moisture permeation, and in the preferred form the polyolefin containing component includes olefin polymers, that is polyolefin or olefin copolymers, namely copolymers formed substantially wholly from olefin monomers, or a mixture thereof. In such compositions, the modified polyolefin makes the moisture resistant polyolefin or olefin copolymer compatible with the epoxy resin or curing agent and facilitates blending to form a blend having a desired degree of homogeneity.

In preferred forms, the composition contains a ratio by weight of said modified polyolefin to said olefin polymers in the range of from 1:2 to 1:30, more preferably of from 1:4 to 1:25, still more preferably from 1:8 to 1:20, and most preferably from 1:10 to 1:15.

Modified polyolefins useful as compatibilizer copolymers in the compositions of the present invention are well known to those of ordinary skill in the art. Examples include polyethylene grafted with maleic anhydride wax such as Licocene (trade-mark) PE-MA 4351 available from Clariant International Ltd., Muttenz, Switzerland or Ovevac (trade-mark) 18365S available from Arkema Inc., Philadelphia, Pa., U.S.A. and polyethylene grafted with maleic anhydride moieties such as Fusabond (trade-mark) EMB265D available from Dupont Company, Wilmington, Del., U.S.A., Amplify (trade-mark) grade GR204 available from Dow Chemical Company, Midland, Mich., U.S.A. and A-C 573A available from Honeywell, Morristown, N.J., U.S.A. Further examples include copolymers of ethylene and acrylic acid such as Primacor (trade-mark) 3150 from Dow, or A-C 540 from Honeywell, or of ethylene and methacrylic acid, such as Nucrel (trade-mark) 599 available from Dupont Company. Still further examples include terpolymers for example a terpolymer of ethylene, acrylic ester and maleic anhydride such as Lotader (trade-mark) 4210, or a terpolymer of ethylene-methylacrylate and glycidyl methacrylate such as Lotader AX 8840, both from Arkema Inc.

While polyethylene is greatly preferred for use as a polyolefin in the present compositions and processes, other polyolefins and copolymers thereof known to confer resistance to moisture penetration can of course be used. Examples of suitable polymers are well known to those skilled in the art and include polypropylene, ethylenepropylene copolymers, and copolymers based on ethylene-butene, ethylene-hexene, ethylene-octene and the like.

Following application of the compositions of the invention, the coatings, which remain curable by virtue of the presence of the curable epoxy resin component and curing agent, may be cured by for example heating or may be allowed to cure at ambient temperature. In order to shorten curing times, preferably the composition includes a cure accelerator for the epoxy resin. Example of such cure accelerators are: aromatic substituted ureas such as U24M from CVC Specialty Chemicals Inc, Amine adducts such as EPIKURE P-101 from Hexion Specialty Chemicals Inc. Houston, Tex. and imidazoles such as IMICURE AMI-1 from Air Products and Chemicals Inc.

Examples of suitable curable epoxy resins in solid form include but are not restricted to resins produced from the reaction of epichlorohydrin and bisphenol A such as DER 6155, 664UE and 667E all from DOW Chemicals and EPON 1004F and 2005 from Hexion Specialty Chemicals Inc. Houston, Tex. Curable epoxy resin produced from the reaction between a liquid epoxy resins and bisphenol A such as EPON 1007F from aforementioned Hexion may also be used. Furthermore, curable novolac modified solid epoxy resins such as DEN 438 and DEN 439 from DOW Chemicals or curable solid resins containing epoxy phenolic novolac such as EPON 2014 can also be used. Further, blends of one or more of solid epoxy resins or those containing bisphenol F and cresol moieties may be employed.

Examples of suitable curing agents include thermally latent curing agents well known to those of ordinary skill in the art and, as will be apparent to one skilled in the art, are preferably selected taking into consideration the residence time and temperature profile in the compounding equipment. Examples of such suitable curing agent are cyanoguanidines (commonly known as DICY) available from CVC Specialty Chemicals Inc under the trade name DDA 10 or from Air Products and Chemicals Inc, Allentown Pa., under the trade name Amicure CG 1200. Hydrazide compounds and hydrazines such as adipic acid dihydrazides (ADH) and isophtalic dihydrazide (IDH) both available from A&C Catalysts inc. Linden N.J., phenolic hardeners such as the DEH line of products (DEH 85) from DOW chemicals anhydrides such as methyl hexahydrophtalic anhydride, nadic methyl anhydride and methyl tetrahydrophthalic anhydride, available from Dixie Chemical Company Inc. Houston Tex. can also be used as curing agents. Aliphatic and aromatic primary and secondary amines and their reaction products with epoxy resins, which are well known to act as curing agents for epoxy resins and need not be discussed in detail herein, may also be employed.

As noted above the function of the filler in the compositions is to improve the physical properties of the coating, especially its impact resistance and hardness. Suitable fillers that may be used in the above described composition for this function are well known to those skilled in the art and include calcium carbonate, calcium sulfate, barium sulfate, clays, for example montmorillonite and bentonite, glass beads and bubbles, microbeads, and mica, silica, feldspar and calcium metasilicate also known as wollastonite.

Preferably, the compositions include functionalized natural rubber, or functionalized synthetic rubber or a mixture thereof. Said functionalized natural or synthetic rubber desirably contains functional groups that are reactive with the epoxy resin or with the epoxy curing agent. Such functionalized rubber makes the polyolefin or olefin copolymer compatible with the epoxy resin or curing agent and facilitates blending to form a blend having a desired degree of homogeneity. Examples of suitable functional groups that may be present on the functionalized rubber include maleic, carboxyl, epoxy and hydroxyl groups.

A blend of polyolefin or olefin copolymer with both modified polyolefin and functionalized rubber may of course also be employed. Examples of suitable functionalized rubbers include maleated rubber such as Kraton FG 1091 from Kraton Polymer U.S. LLC, Houston, Tex., epoxidized rubber such as Technirez RME-912 from A&C catalyst Inc, South Plainfield N.J., a carboxylated terminated butadiene acrylonitrile rubber modified epoxy, or hydroxylated rubber such as poly BD 605E from Sartomer Company Inc. Exton Pa. Further, these functionalized rubbers improve the low temperature properties of the coating, especially its impact resistance, improve its flexural properties and avoid brittleness. In a preferred form, the content of said rubbers is 0.5 to 4% by weight based on the total weight of the composition, more preferably 1 to 2.5%.

In preferred forms of the present composition and process, the composition is as indicated in Table 1, in percent by weight based on the total weight of the composition:

TABLE 1

| Component | Preferred | More Preferred | Most Preferred |
|---|---|---|---|
| Polyolefin or Olefin | 20-90 | 35-80 | 60-80 |
| Copolymers | | | |
| Modified Polyolefin | 0-20 | 2-10 | 4-6 |
| Curable solid epoxy | 3-60 | 8-30 | 12-20 |
| resin | | | |
| Filler | 1-40 | 10-30 | 15-25 |
| Epoxy curing agent | 0.2-2.5 | 0.3-1.5 | 0.5-0.8 |
| Cure accelerator | 0.004-0.06 | 0.008-0.03 | 0.01-0.02 |
| Functionalized | 0-5 | 0.5-4 | 1-2.5 |
| rubber | | | |

In the preferred form, the present compositions are substantially wholly free of polyester. The presence of polyester in coatings may tend to render them susceptible to degradation to an undesired degree in high pH environments, such as the environment of a metallic cathodically protected pipe.

While the above description provides ample information for one skilled in the art to make and use the present composition and to carry out the present process, for the avoidance of doubt some detailed Examples will be given:

### EXAMPLE 1

### Compounding

A BUSS Ko-Kneader (trade-mark) compounder type ASV 46 heated to a barrel temperature between 130° C. and 140° C. was used to compound a mixture.

Compounding Method 1a

The compounder was operated in such way that solid pellets (medium density polyethylene (MDPE), and polyethylene grafted maleic anhydride (PEGMA)) were fed at the beginning of the barrel and roughly halfway down the barrel, in the direction of flow to the pelletizer, a funnel fitted with an auger was used to feed powders or small particulates (epoxy resin, fillers, curing agent and cure accelerator).

The composition was as in Table 2 below.

TABLE 2

| TYPE | Supplier | GRADE | g per kg |
|---|---|---|---|
| MDPE | Flint Hill Resources | M 4101 | 694 |
| PEGMA | Dupont | Fusabond EMB- | 50 |
| | | 265D | |
| EPOXY | Dow | DER 6155 | 150 |
| FILLER | NYCO | Nygloss 8 | 25 |
| Bulk Filler | NYCO | NYAD 400 | 75 |
| CURE | CVC Specialty | DDA10 | 5.85 |
| | Chem. | | |
| ACCELERATOR | CVC Specialty | U24M | 0.15 |
| | Chem. | | |

The bulk of the composition was composed of a medium density polyethylene (Vicat softening point 116° C.) with a Melt Flow Index (190° C. at 2.16 kg) of 7.0 to which a compatibilizer was added in the form of a maleic anhydride grafted PE.

The epoxy used was a medium molecular weight epoxy (DER 6155) with a softening point between 105° C. and 125° C. The curing agent was a micronized dicyandiamide from CVC and the accelerator a substituted urea compound again from CVC. The fillers used were wollastonite fillers from NYCO with particle size suitable for powder spraying.

Exiting from the compounder barrel, the compounded mixture was pelletized and cooled down using process water. Once cooled, the pellets were dried overnight and stored in air-tight containers.

Compounding Method 1b

Another compounding method consisted of dry blending all the ingredients described in Table 2 and feeding the blended mixture at the beginning of the barrel. In this second compounding method, the polyethylene and compatibilizer are preferably in a coarsely ground state to facilitate the blending of the various ingredients.

Two application methods were tested, a first one based on a powder spraying system and a second one simulating an extrusion-like application.

Powder Application:

Grinding

The dry compounded pellets, obtained using compounding method 1a, were chilled to a temperature of −50° C. and ground using a Powder King (trade-mark) (PK-18) laboratory grinder. Particles passing a 180 μm sieve (−180 microns) were retained for use in spraying.

Spraying:

Steel panels were grit blasted and thermally pickled in conventional manner. The panels were preheated in an oven to 240° C. and a 8-10 mils layer of a standard epoxy was sprayed unto the panels. Subsequently a 10 to 25 mils layer of the compounded mixture particles was sprayed using a modified spray gun fitted with a small funnel. (1 mil is equal to 0.001 inch.). The panels were then immediately placed back in the oven maintained at 240° C. for a period of no less than 3 minutes and then dipped in a bucket of water at room temperature.

### EXAMPLES 2-12

The protective coatings listed in Table 3 and 4 were obtained by first electrospraying a layer of 3M Scotchkote 6233 or DuPont NapGuard 7-2514 8 mils±2 mils thick followed by a 14 mils±4 mils thick layer of the respective formulation.

These formulations were compounded and ground as described above in Example 1. Examples 2 and 3 were compounded using compounding method 1b, while the remaining formulations were compounded using compounding method 1a.

On testing, as indicated in Tables 3 and 4, as with the coating obtained in Example 1, it was found that the resulting coating was very well bonded together and the pull off strength was often limited by the adhesion between the second coat and the dolly. Adhesive failure between the first epoxy layer and the topcoat was rarely observed.

TABLE 3

| [symbol] | #2 [symbol] | #3 [symbol] | #4 [symbol] | #5 [symbol] | #6 [symbol] | #7 [symbol] | #8 | #9 [symbol] |
|---|---|---|---|---|---|---|---|---|
| [symbol] | (g/kg) [symbol] | (g/kg) [symbol] | (g/kg) [symbol] | (g/kg) [symbol] | (g/kg) [symbol] | (g/kg) [symbol] | (g/kg) [symbol] | (g/kg) [symbol] |
| RMS | 694 | 644 | 0 | 0 | 0 | 0 | 595.8 | 0 |
| 539* | | | | | | | | |
| FHRM | 0 | 0 | 694 | 700 | 645.8 | 645.8 | 0 | 595.8 |
| 4101 | | | | | | | | |
| Fusabond | 50 | 100 | 50 | 50 | 50 | 50 | 50 | 50 |
| 265D | | | | | | | | |
| DER | 150 | 150 | 150 | 242 | 150 | 150 | 150 | 150 |
| 6155 | | | | | | | | |
| Nygloss 8 | 100 | 100 | 100 | 0 | 0 | 0 | 50 | 0 |
| NYAD | 0 | 0 | 0 | 0 | 0 | 150 | 150 | 200 |
| 400 | | | | | | | | |
| MINEX | 0 | 0 | 0 | 0 | 150 | 0 | 0 | 0 |
| 4** | | | | | | | | |
| DDA10 | 5.85 | 5.85 | 5.85 | 7.93 | 4.00 | 4.00 | 4.00 | 4.00 |
| U24M | 0.292 | 0.292 | 0.292 | 0.292 | 0.292 | 0.292 | 0.292 | 0.292 |
| Additives | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| Carbon | [symbol] | [symbol] | [symbol] | [symbol] | [symbol] | [symbol] | [symbol] | [symbol] |
| Black | | | | | | | | |
| Shore D | [symbol] | [symbol] | 62.6 | [symbol] | 55.0 | [symbol] | 65.3 | [symbol] |
| ASTM | [symbol] | [symbol] | ±0.5 | [symbol] | ±0.3 | [symbol] | ±0.5 | [symbol] |
| 2240 | | | | | | | | |
| Pull | 2000 | 2800 | 2195 | 2200 | 2800 | 3200 | 3285 | >3000 |
| OFF | | | | | | | | |
| D 4541 | [symbol] | ±100 | [symbol] | ±200 | ±440 | ±20 | ±15 | [symbol] |
| (psi) | [symbol] | [symbol] | [symbol] | [symbol] | [symbol] | [symbol] | [symbol] | [symbol] |
| Impact | 4-6 | 6-8 | 4-6 | 4-6 | 6-8 | 6-7.5 | 6-7.5 | 6-8 |
| (−30° C. | [symbol] | [symbol] | [symbol] | [symbol] | [symbol] | [symbol] | [symbol] | [symbol] |
| in J) | | | | | | | | |
| CSA | [symbol] | [symbol] | [symbol] | [symbol] | [symbol] | [symbol] | [symbol] | [symbol] |
| Z245.20- | | | | | | | | |
| 06 | | | | | | | | |

*SURPASS (trade-mark) RMS539 is an MDPE available from Nova Chemicals, Calgary, Alberta, Canada.
**MINEX (trade-mark) 4 is a nepheline syenite filler from Unimin Specialty Minerals Inc., New Canaan, CT, U.S.A.

TABLE 4

| [symbol] | #10 [symbol] | #11 [symbol] | #12 [symbol] |
|---|---|---|---|
| [symbol] | (g/kg) [symbol] | (g/kg) [symbol] | (g/kg) [symbol] |
| RMS 539 | 582.6 | 581 | 580 |
| FHRM 4101 | 0.0 | 0 | 0 |
| Fusabond 265D | 50.1 | 50 | 50 |
| DER 6155 | 150.4 | 150 | 150 |
| Nygloss 8 | 50.1 | 50 | 50 |
| NYAD 400 | 150.4 | 150 | 150 |
| MINEX 4 | 0 | 0 | 0 |
| DDA10 | 6.02 | 6.00 | 6.00 |
| U24M | 0.439 | 0.433 | 0.433 |
| Additives | +5 g/kg CIBA | +10 g/kg DOW | +10 g/kg |
| [symbol] | Tinuvin 144 | Fortegra 664-12 | Technirez |
| [symbol] | [symbol] | [symbol] | RME-912 |
| Carbon Black | traces ≦5 g/kg | traces ≦5 g/kg | traces ≦5 g/kg |
| Shore D | 61.8 | 65.4 | 64.2 |
| ASTM 2240 | ±0.2 | ±0.5 | ±0.4 |
| Pull OFF | >3000 | >3000 | >3000 |
| D 4541 | [symbol] | [symbol] | [symbol] |
| (psi) | [symbol] | [symbol] | [symbol] |
| Impact | 6.5 to 8 | 6.5 to 8 | 6.5 to 8 |
| (−30° C. in J) | [symbol] | [symbol] | [symbol] |
| CSA Z245.20-06 | [symbol] | [symbol] | [symbol] |

In Examples 10, 11 and 12, a black polyethylene-based masterbatch 19717 from Ampacet, Tarrytown, N.Y., was added to colour and stabilize the coating. This is a common practice and depending on the end products requirements, various master batches are commercially available to colour coatings and ensure that it will meet UV or thermal stability standards. This practice is well known to a person skilled in the art and need not be discussed in detail herein. Furthermore, Tinuvin 144, an antioxidant, from CIBA was added in Example 10 for its recognized triboelectric and antioxidant activity in coatings.

### EXAMPLE 13

### Film (Extrusion-Like) Application

The dry pellets obtained as described in Example 1, using compounding method 1a, were melted in a Brabender mixer at 140° C. (±10° C.) for a period of no less than three minutes. The molten mixtures was placed in rectangular molds and pressed at a temperature of roughly 130° C. Once cooled the resulting films were 8 inches wide by 8 inches long and 30 mils thick. The low temperature used during the compression molding operation was to reduce the amount of reaction that could have occurred prior to being applied.

Steel panels were grit blasted and thermally pickled. The panels were preheated in an oven to 240° C. and a 8-10 mils layer of standard epoxy was sprayed unto the panel. Subsequently a small sample of the cut 30 mils thick film was placed on top of the epoxy. The panel was then immediately placed back in the oven maintained at 240° C. for a period of no less than 3 minutes and then dipped in a bucket of water at room temperature.

The resulting coating is bonded together. This trial shows that the second layer can be applied using extrusion on top of a sprayed first epoxy layer.

### EXAMPLE 14-16

TABLE 5

| [symbol] | #14 [symbol] | #15 [symbol] | #16 [symbol] | #17 [symbol] |
|---|---|---|---|---|
| [symbol] | (g/kg) [symbol] | (g/kg) [symbol] | (g/kg) [symbol] | (g/kg) [symbol] |
| RMS 539¹ [symbol] | 0 | 588.2 | 0 | 294.1 |
| RMS 244 | 0 | 0 | 588.2 | 294.1 |
| Total | 588.2 | 0 | 0 | 0 |
| 4041UV² [symbol] | | | | |
| Fusabond 265D | 50 | 50 | 50 | 50 |
| DER 6155 | 150 | 150 | 150 | 150 |
| DER 664U | 0 | 0 | 0 | 0 |
| Nygloss 8 | 50 | 50 | 50 | 50 |
| NYAD 400 | 150 | 150 | 150 | 150 |
| DDA10 | 4.3 | 4.3 | 4.3 | 4.3 |
| Ampacet 19717 | 5 | 5 | 5 | 5 |
| Tinuvin 144 | 2.5 | 2.5 | 2.5 | 2.5 |

¹SURPASS (trade-mark) RMS244 is a PE available from Nova Chemicals, Calgary, Alberta, Canada.
²Total 4041UV is an MDPE produced by Total Petrochemicals and distributed in Canada by Arkema Canada Inc, Oakville, Ontario, Canada

### EXAMPLE 14

The dry pellets obtained as described using compounding method 1a and with a composition described in Table 5 above (see #14), were extruded using a single screw 1.5° diameter Deltaplast extruder (24:1 L over D ratio) fitted with an adjustable sheet die. A very uniform sheet was obtained and was strong enough to resist tearing during application on a rotating pipe covered with FBE.

Steel pipes (4 to 6 inches OD with a 0.125 to 0.5 inch wall thickness and 6 to 18 inches long) were grit blasted and thermally pickled in conventional manner. The pipes were then preheated in an oven to 240° C. and a 8-10 mils layer of a standard FBE (3M Scotchkote 6233) was applied using a dip coating method into a fluidized bed. Within a period of a maximum of 15 seconds from being removed from the fluidized bed, the thus FBE coated pipe was set-up into a pipe rotator apparatus that could rotate the pipe at an adjustable rate ranging from 1 to 20 revolutions per minutes. A sheet of the #14 material was then extruded directly over the curing FBE. Non-stick roller(s) (silicon rubber or fluorinated polymer) were then used to ensure intimate contact between the extruded sheet and the FBE coated pipe.

When the layer of extruded coating had been built to the specified thickness the pipe was removed from the rotator and placed back into an oven maintained at 240° C. for a period of no less than 60 seconds. This was necessary because the relatively small pipes tend to cool down rather quickly in the lab environment especially when in contact with the rotator. The pipe was then immersed in water maintained at room temperature.

The extruded coating was very uniform, adhered well to FBE and the adhesion reached the 3000 psi level when measured according to ASTM D4541. The adhesion was often limited by the adhesion of the extruded coating to the dolly used for the pull off adhesion test.

All tested samples also easily met the Hot Water Soak, cathodic disbondment (CD) required in CSA Z.245-21.06 system B2 and the cathodic disbondement for a rating of 95° C. (28 days at 95° C. below or equal to 15 mm) as required in ISO DIS 21809-1.

### EXAMPLE 15

The material (formulation #15 in Table 5 above) was compounded in a Banbury mixer fitted with a cooling system. The PE, fillers and maleated PE (Fusabond 265D) were first blended together until an homogenous melt was achieved and then the remaining ingredients were added and further mixed for a short period of time typically 2 minutes. The resulting molten mixture was ejected from the Banbury mixer and extruded using a short single screw conveying extruder and pelletized using a hot face die cutter. The produced pellets were cooled on a vibrating tray and packed in airtight self-sealing bags.

In a typical plant configured to apply a 3 layer PE (3LPE) coating by the side wrap method (as taught for example in U.S. Pat. Nos. 3,823,045 in the name Hielma, 4,510,007 in the name Stucke and 4,211,595 in the name Samour, the disclosures of all of which are incorporated herein by reference) formulation #15 was applied in the following manner. Sections of 0.250 inch thick 8⅝′ diameter ERW pipes were grit blasted, preheated to about 90° F. (32° C.) and washed with Oakite(trade mark) 31 (available from Chemetall Canada, Bramalea, Ontario Canada). After rinsing with deionized water, the pipe was further heated to a surface temperature of 460±10° F. before entering the spray booth and coated with various thicknesses of FBE (DuPont Nap Guard® 7-2514). Material formulation #15 was extruded onto the sprayed FBE within a period of time equivalent to 0.1 to 4.5, most preferably 0.5 to 2 and even more preferably within a period of time equivalent to the gel time of the FBE at the pipe surface temperature. The single screw extruder fitted with a sheet die was located approximately 20 inches (50.8 cm) from the position of the last FBE spray gun.

The coated pipe was then conveyed to a quench section as normally employed when coating a pipe with a 3LPE. Typical Impact resistance results are given in Table 6 below:

TABLE 6

| | | ^{‡}FBE | Total | | | ^{‡}FBE | Total | |
|---|---|---|---|---|---|---|---|---|
| | | Bottom | coating | | | Bottom | coating | |
| | ID | Thickness | Thickness | | ID | Thickness | Thickness | |
| Test [symbol] | # [symbol] | (mils) [symbol] | (mils) [symbol] | Result [symbol] | # [symbol] | (mils) [symbol] | (mils) [symbol] | Result [symbol] |
| 3J @ −50° C. [symbol] | A | 7-11 | 46.6 | Pass | P | 14-20 | 47 | Pass |
| CSA [symbol] | B | 7-11 | 35.9 | Pass | Q | 14-20 | 36 | Pass |
| Z20-245.20 [symbol] | C | 7-11 | 37.9 | Pass | R | 14-20 | 38 | Pass |
| 6.8J | D | 7-11 | 35.5 | Pass | S | 14-20 | 36 | Pass |
| @10° C. [symbol] | | | | | | | | |
| Aramco [symbol] | E | 7-11 | 49.1 | Pass | T | 14-20 | 49 | Pass |
| 09-SA | F | 7-11 | 44.8 | Pass | U | 14-20 | 45 | Pass |
| MSS-089 [symbol] | | | | | | | | |
| 11.8J @ | G | 7-11 | 56.3 | Pass | V | 14-20 | 44 | Pass |
| 10° C. [symbol] | | | | | | | | |
| Aramco [symbol] | H | 7-11 | 50.9 | Pass | W | 14-20 | 49 | Pass |
| 09-SA | I | 7-11 | 48.6 | Fail [symbol] | X | 14-20 | 53 | Pass |
| MSS-089 [symbol] | | | | | | | | |
| 15J @ | J | 7-11 | 37.3 | Pass | Y | 14-20 | 37 | Pass |
| 23° C. [symbol] | | | | | | | | |
| (25 mm | K | 7-11 | 46.4 | Pass | Z | 14-20 | 46 | Pass |
| head) [symbol] | | | | | | | | |
| DIS- | L | 7-11 | 55.2 | Pass | AA | 14-20 | 55 | Pass |
| 21809 | | | | | | | | |
| 21J @ | M | 7-11 | 41.5 | Pass | AB | 14-20 | 42 | Pass |
| 23° C. [symbol] | | | | | | | | |
| (25 mm | N | 7-11 | 48.7 | Pass | AC | 14-20 | 49 | Pass |
| head) [symbol] | | | | | | | | |
| DIS- | O | 7-11 | 45.1 | Pass | AD | 14-20 | 45 | Pass |
| 21809 | | | | | | | | |

Samples A to AD all pass the flexibility requirements as specified in CSA Z-245.20-06 and DIS 21809 for the three following conditions: i) 5.75° per pipe diameter length (°/pdl) at 23° C., ii) 3.75°/pdl at 0° C. and iii) 2°/pdl at −40° C.

### EXAMPLE 16 AND 17

Material formulations #16 and 17 of Table 5 were compounded and applied using the same preparation and application methods as described in example #14. However, a 1 inch thick pipe was used to minimize heat losses. After the sheet was extruded onto the pipe section, it was therefore not placed back in the oven and after standing in air for 60 seconds, a small stream of tap water (about 100 ml per minute) was directed inside the pipe to simulate an internal quenching process as disclosed in Canadian application 2,642,093 in the name of the present assignee and in U.S. Pat. No. 6,270,847 in the name Wong et al. The disclosures of both of these are incorporated herein by reference. After internal cooling for 180 seconds the pipe was dipped in water maintained at room temperature.

Again the extruded coating adhered well to the FBE coated pipe.

### EXAMPLES 18 AND 19

TABLE 7

| [symbol] | #18 [symbol] | #19 [symbol] | [symbol] | [symbol] |
|---|---|---|---|---|
| [symbol] | Part A [symbol] | Part B [symbol] | Part A [symbol] | Part B [symbol] |
| [symbol] | (g) [symbol] | (g) [symbol] | (g) [symbol] | (g) [symbol] |
| RMS 539 | 134 | 134 | 295.5 | 295.5 |
| TR-0535 UI¹ [symbol] | 160 | 160 | [symbol] | [symbol] |
| Fusabond 265D | 25 | 25 | 25 | 25 |
| DER 6155 | 0 | 150 | 0 | 150 |
| Nyglos 8 | 25 | 25 | 25 | 25 |
| NYAD 400 | 75 | 75 | 75 | 75 |
| DDA10 | 4.3 | 0 | 2.8 | 1.5 |
| Ampacet 19717 | 1 | 1 | 0 | 2 |
| Tinuvin 144 | [symbol] | [symbol] | 2.5 | [symbol] |
| Irganox B | 5 | [symbol] | [symbol] | [symbol] |
| 900² [symbol] | | | | |

¹Novapol (trade-mark) TR-0535UI is a PE available from Nova Chemicals, Calgary, Alberta, Canada.
²Iganox B900 (trade-mark) is a heat stabilizer and processing aid available from Ciba division of BASF, Ludwigshafen, Germany.

Material formulations #18 and 19 of Table 5 were compounded generally in the manner described above under compounding method 1a using a 38 mm Twin screw extruder at a barrel temperature ranging from 135° C. to 165° C. For each formulation, the two Parts A and B were compounded separately and then mixed in a ratio of 1.33 part by weight of Part B to 1 part by weight of Part A. The ratio of Part A to Part B was calculated to obtain a blended composition by weight that is similar to the formulations described above.

The material was applied to an FBE covered steel pipe as described in Example 14.

The extruded coating adhered well to the FBE coated pipe with a pull off adhesion reaching 3000 psi as measured by ASTM D4541.

1-42. (canceled)

43. A coating composition comprising in admixture:
(A) a curable epoxy resin in solid form;
(B) a curing agent for the epoxy resin;
(C) a polyolefin containing component comprising at least one of (i) a compatibilizer polymer that is a modified polyolefin or (ii) a mixture of a polyolefin or olefin copolymer with a functionalized rubber; said modified polyolefin and said functionalized rubber containing functional groups reactive with either the epoxy resin or epoxy curing agent; and
(D) a filler in particulate form, wherein a polyolefin-based portion amounting to at least 50% by weight of said polyolefin containing component (C) and an epoxy-based portion amounting to at least 50% by weight of said curable epoxy resin (A) have viscosities such that the difference between the viscosity of said polyolefin-based portion and the viscosity of said epoxy-based portion, expressed as a percentage based on the lower of the two viscosities, is less than 40%, wherein said viscosities of said polyolefin-based portion and of said epoxy-based portion are measured by ASTM D4440 at the Vicat softening points thereof as measured by ASTM D1525.

44. Composition according to claim 43 wherein the difference between the Vicat softening point of said polyolefin containing component (C) and of said curable epoxy resin (A) is a value less than 30° C.

45. Composition according to claim 43 wherein said component (C) or said component (A) has a range of Vicat softening points and said difference is determined commencing from the lowest temperature of said range.

46. Composition according to claim 43 wherein said polyolefin containing component (C) further comprises:
(E) a polyolefin or a copolymer thereof in admixture with said compatibilizer copolymer.

47. Composition according to claim 43 including (F) a cure accelerator for said epoxy resin.

48. Composition according to claim 43 wherein said functionalized rubber comprises a functionalized natural rubber, synthetic rubber or a mixture thereof.

49. Composition according to claim 43 that is substantially wholly free of polyester.

50. Composition according to claim 43 provided in the form of two separate parts, one of which contains all or a fraction of said curable epoxy resin and the other of which contains all or a fraction of said curing agent.

51. Process for forming a coating composition comprising blending together a mixture comprising:
(A) a curable epoxy resin in solid form;
(B) a curing agent for the epoxy resin;
(C) a polyolefin containing component comprising at least one of (i) a compatibilizer polymer that is a modified polyolefin or (ii) a mixture of a polyolefin or olefin copolymer with a functionalized rubber; said modified polyolefin and said functionalized rubber containing functional groups reactive with either the epoxy resin or epoxy curing agent; and
(D) a filler in particulate form, including conducting said blending at a temperature sufficiently elevated to render said polyolefin containing component (C) and said epoxy resin (A) flowable and blending in flowable state to form a flowable blend, and allowing said mixture to cool to form a solid blend.

52. Process according to claim 51 including blending said mixture to form a substantially homogeneous blend having said filler substantially uniformly distributed therein.

53. Process according to claim 51 wherein said polyolefin containing component (C) further comprises:
(E) a polyolefin or a copolymer thereof in admixture with said compatibilizer copolymer.

54. Process according to 51 wherein said mixture includes (F) a cure accelerator for said epoxy resin.

55. Process according to claim 53 wherein said blend includes a functionalized natural rubber, a functionalized synthetic rubber or a mixture thereof, preferably 0.5 to 4% by weight, based on the total weight of the blend, of said functionalized natural rubber, functionalized synthetic rubber or mixture thereof.

56. Process according to claim 51 wherein the blend is substantially wholly free of polyester.

57. Process for applying a coating composition on a substrate comprising a process according to claim 51 including the step of applying said flowable blend on a substrate before allowing said flowable blend to cool.

58. Process according to claim 57 wherein said substrate is an elongated metallic object, preferably a metal pipe.

59. Process according to claim 57 wherein said substrate is coated with FBE before application of said flowable blend thereon.

60. Process according to claim 59 wherein said flowable blend is applied before the occurrence of full cure of the FBE.

61. A blend produced by a process according to claim 51.

62. A coated substrate produced by a process according claim 57.
